(19) United States
(12) Patent Application Publication
(10) Pub. No.: US 2008/0170805 A1
(43) Pub. Date: Jul. 17, 2008

(54) METHOD AND SYSTEM FOR ADDING DYNAMIC PICTURES TO REAL-TIME IMAGE

(75) Inventors: Kuo Hsiang Sun, Taipei (TW); Chin Yuan Teng, Taipei (TW); Hsiu Ling Chiu, Taipei (TW); Wen-Shiu Hsu, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., TAIPEI CITY (TW)

(21) Appl. No.: 12/013,242

(22) Filed: Jan. 11, 2008

(30) Foreign Application Priority Data
Jan. 17, 2007 (TW) 96101727

(51) Int. Cl. G06K 9/36; H04N 5/262

(52) U.S. Cl. 382/284; 348/239; 348/E05.051

(57) ABSTRACT

A method for adding a dynamic picture to a real-time image and a system thereof are disclosed. First, a source image is obtained, and an image processing is executed on the source image to produce an image with a specific format. Then, a dynamic signet image is produced by integrating a plurality of images with a specific format and stored into a database. A dynamic signet image is loaded from the database and added to a real-time video streaming.

### BACKGROUND OF THE INVENTION

1. Field of the Invention

The invention relates to an image processing method and, more particularly, to a method and a system for adding a dynamic picture to a real-time image.

2. Related Art of the Invention

The “signet” is an image revealing itself as a signet and used personally in a literal file or an image file. The “dynamic signet” is a personally used image signet revealing itself as several successive images dynamically. The technology of the “dynamic signet” has been developed and used by a minority of manufacturers and mainly used in literal or image files, but it has not been used in a video streaming.

Therefore, the invention provides a method and system for adding a dynamic picture to a real-time image.

### BRIEF SUMMARY OF THE INVENTION

To obtain the above or other objectives, one embodiment of the invention discloses a method for adding a dynamic picture to a real-time image. The method includes steps of obtaining a source image, executing an image processing on the source image to produce an image with a specific format, producing a dynamic signet image by integrating a plurality of the images with the specific format, storing the dynamic signet image into a database, loading a dynamic signet image from the database, and adding the loaded dynamic signet image to a real-time video streaming.

One embodiment of the invention further discloses a system for adding a dynamic picture to a real-time image. The system includes a storage medium, an image capture device, a dynamic signet producing module and a video processing module. The image capture device is used to obtain a source image. The dynamic signet producing module is used to execute an image processing on the source image to produce an image with a specific format, integrate a plurality of images with the specific format to produce a dynamic signet image, and store the dynamic signet image in the storage medium. The video processing module is used to load a dynamic signet image from the database and add the loaded dynamic signet image to a real-time video streaming.

### BRIEF DESCRIPTION OF THE DRAWINGS

FIG. 1 is a schematic diagram showing a system frame of adding a dynamic picture to a real-time image of one embodiment of the invention.

FIG. 2 is a flowchart showing the steps of the method of adding a dynamic picture to a real-time image of one embodiment of the invention.

FIG. 3 is a schematic diagram showing how to produce a dynamic signet image.

FIG. 4 is a schematic diagram showing how to add a dynamic picture to a real-time image.

### DETAILED DESCRIPTION OF THE EMBODIMENTS

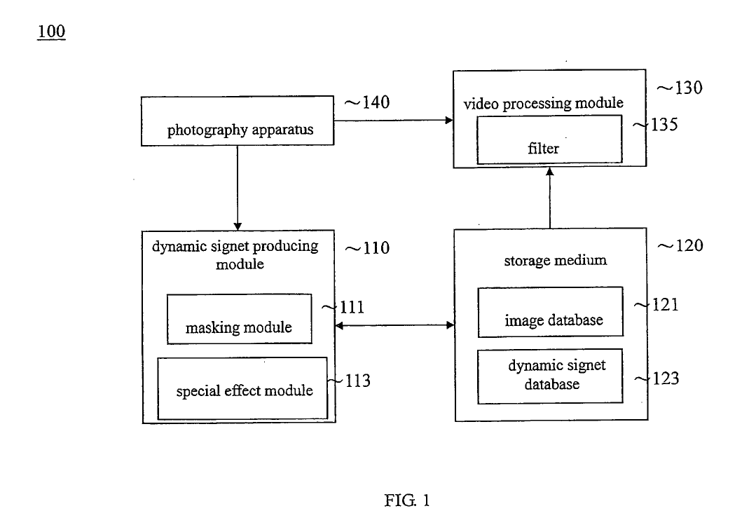

To make the objectives, the features and the advantages of the invention clearer and more understandable, the description will be given hereinbelow with appended FIG. 1 to FIG. 4 and preferred embodiments in detail. Different embodiments in the specification of the invention are used to describe technology features of different embodiments of the invention. In addition, the configuration of the elements in the embodiments is used for describing instead of limiting the invention. Some of the reference numbers in FIG.s are repeated for concise purpose instead of the relationship between different embodiments.

One embodiment of the invention discloses a method and a system for adding a dynamic picture to a real-time image.

FIG. 1 is a schematic diagram showing a system frame of adding a dynamic picture to a real-time image of one embodiment of the invention. The computer system 100 provided by a preferred embodiment of the invention includes a dynamic signet producing module 110, a storage medium 120, a video processing module 130 and an image capture device 140, wherein the dynamic signet producing module 110 includes a masking module 111 and a special effect module 113, the storage medium 120 includes an image database 121 and a dynamic signet database 123, and the video processing module 130 includes a filter 135.

Both the image capture device 140 and the storage medium 120 are coupled to the dynamic signet producing module 110 and the video processing module 130, respectively.

The functions of the dynamic signet producing module 110 and the video processing module 130 can be achieved via hardware or software.

If functions of the dynamic signet producing module 110 and the video processing module 130 are achieved via hardware, the dynamic signet producing module 110 can be electrically connected to the image capture device 140 and the storage medium 120, respectively. Similarly, the video processing module 130 can also be electrically connected to the image capture device 140 and storage medium 120, respectively. Then, the dynamic signet producing module 110 and the video processing module 130 can be integrated into one image processing chip, or the functions thereof can be achieved by at least one application specific integrated circuit (ASIC), respectively.

If the functions of dynamic signet producing module 110 and the video processing module 130 are achieved by software, the dynamic signet producing module 110 and the video processing module 130 are preferred to be a part of application programs stored in the computer system 100 and can receive image pictures provided by the image capture device 140.

In the embodiment, the computer system 100 is preferred to be a portable computer system such as a laptop system, a notebook system, a tablet personal computer (PC) system, a palmtop system or an ultra mobile personal computer (UMPC) system. In other embodiments, the computer system 100 can also be a desktop computer system, a bare bone system or a server.

In the embodiment, the image capture device 140 is a webcam assembled in a portable computer system. In other embodiments, the image capture device 140 can be an image pick-up apparatus which is independent of the computer system 100. The computer system 100 can obtain a plurality of images of an objective via the image capture device 140, wherein the images of the objective can be the images of a person or an object.

The dynamic signet producing module 110 is used to produce a dynamic signet image. The dynamic signet producing module 110 can receive a plurality of images to be processed captured by the image capture device 140 or transfer the produced dynamic signet images to the storage medium 120 to store the produced dynamic signet images in the dynamic signet database 123. In addition, the dynamic signet producing module 110 can also load a plurality of images to be processed from the image database 121 of the storage medium 120. In other words, in the embodiment, the resource of the images to be processed of the dynamic signet producing module 110 can be the image capture device 140 or the image database 121 of the storage medium 120, wherein the image database 121 stores a plurality of images to be processed.

In addition, the dynamic signet producing module 110 can execute a masking processing via the masking module 111 or an image special effect processing via a special effect module 113 on a plurality of images to be processed to obtain a signet image with a portable network graphics (PNG) format. Then, the dynamic signet producing module 110 can integrate the signet images with the PNG format to obtain a dynamic signet image. Afterward, the dynamic signet producing module 110 can store the produced dynamic signet image to the dynamic signet database 123.

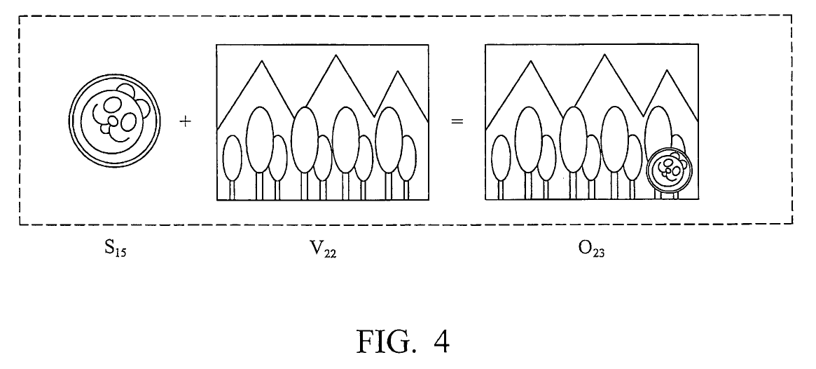

The video processing module 130 can obtain a real-time video streaming via the image capture device 140 and load a dynamic signet image from the dynamic signet database 123 simultaneously to make the dynamic signet image appear with the information displayed on the display simultaneously. (shown as O₂₃ in FIG. 4)

In the embodiment, the filter 135 adds each image of the dynamic signet image to the frames of the real-time video streaming according to the time point when the dynamic signet image is loaded, the time point of showing each image of the dynamic signet image and the time interval each image of the dynamic signet image lasts. For example, a dynamic signet includes three image pictures, and each image picture stays for one second. The video streaming which is playing is fifteen frames per second. Therefore, the filter must add the first image picture of the dynamic signet to the designated position of the first frame to the tenth frame, add the second frame of the dynamic signet to the eleventh frame to the twentieth frame, and add the third frame to the twenty-first frame to the thirtieth frame. After that, the filter adds the first image picture of the dynamic signet to the designated position of the thirty-first frame to the fortieth frame. By analogy, the image pictures of the dynamic signet are repeated to be added to the frames in a fixed interval. Thus, the signet is shown dynamically.

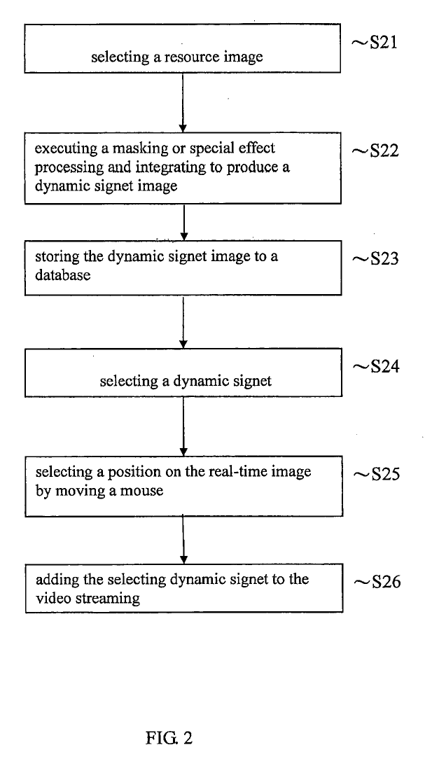

FIG. 2 is a flowchart showing the steps of the method of adding a dynamic picture to the real-time image of one embodiment of the invention. As for the description of the FIG. 2, please also refer to FIG. 1.

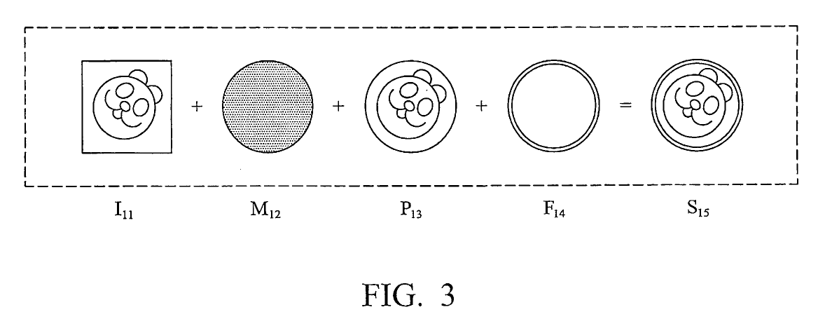

First, a source image is obtained (step S21). For example, the step S21 is capturing an image by a web cam or loading an image form an image database. As shown in FIG. 2, an image I₁₁ is loaded from an image database, wherein the image I₁₁ is an image with any format. After that, the masking or special effect processing is executed on the obtained image to produce an image with a specific format (step S22). As shown in FIG. 3, a mask M₁₂ is added to the image I₁₁ to produce an image whose edge is cut. The mask M₁₂ can be an image with a PNG format. The color of an image with a PNG format has transparency (Alpha, 255 represents absolutely non-transparent, and 0 represents absolutely transparent), and the edge of the initial image can be cut after the processing according to the mask. Different masks can produce different outlines. An image P₁₃ with a PNG format can be obtained after the masking or special effect processing, wherein the outline of image P₁₃ is identical with that of the mask M₁₂. An outline border F₁₄ is added to the image P₁₃ with the PNG format to obtain a signet image S₁₅.

A dynamic signet image can be obtained by integrating a plurality of signet images with a PNG format, and the produced dynamic signet image is stored into a database (step S23). In the step S22, when different masks or outline borders are used, the images with different outlines and effects can be produced. After that, a dynamic signet image is selected from the database (step S24); an input device such as a mouse is used to select a position in a video streaming to put the dynamic signet image (step S25); the selected dynamic signet image is added to the real-time video streaming (step S26), as shown in FIG. 4.

The integration process between the dynamic signet image and the real-time video streaming will be described concisely hereinbelow.

The method for adding a dynamic picture to real-time video streaming of one embodiment of the invention is achieved by utilizing a filter. A plurality of successive frames can be obtained when the filter is used in a real-time streaming. Each frame is processed and transferred to the next filter after being processed. Thus, the content users see can be changed.

The position where the dynamic signet image will be put should be determined first before the dynamic signet image is loaded. The filter can add each image of the dynamic signet image to the frames of the real-time video streaming according to the time point when the dynamic signet image is loaded and the time point of showing each image of the dynamic signet image, and the time interval each image of the dynamic signet image lasts.

The image special effect processing in the step S22 is described hereinbelow. The binary system array data in an image can be extracted and processed. A 640×480 picture can be viewed as a 640×480 array. Each pixel of the array data includes information about three colors, red (R), green (G), blue (B), and each color occupies one byte. That is, the information of three bytes is used to represent the color of a pixel. The special effect processing is usually used to make change according to the content of the pixel or other pixels. For example, the values of the G and B of each pixel are set up to be 0, and the initial value of R is maintained. Thus, the produced picture only appears red, and brightness will be reduced. The followings are the common image special effect processing.

Blurring is changing the color information of each pixel to the average value of the color of the adjacent pixels and the initial pixel. That is, the values of the R, G, B of the top-left, top, top-right, left, medium (initial reference point), right, bottom-left, bottom, bottom-right pixels, which are nine pixels, are added together, and after being added, they are divided by nine (If the pixels are on the edge or in the corner, they are averaged according to the situation.) to replace the initial color information. Since the color value of each pixel of the whole picture is nearer to the color value of the adjacent pixel, the blurring effect can be obtained.

Negative is executing a logic operation XOP between the values of the R, G, B in the color information of each pixel and 0xFF. If the initial value of R is 100, the new value will become 255−100=155. Thus, the color information of the whole picture is absolutely opposite to the initial color information to produce the effect of the photo negative.

Mosaic is taking a grid with fixed size as a unit of a picture, calculating the average value of the R, G, B values of all pixels in the unit, and replacing the R, G, B values of all the pixels by the average value. Taking a 640×480 picture as example, if 4×4 grid is used to make a mosaic effect, the picture is divided into 160×120 areas first, and the average R, G, B values in each area are calculated and replace the initial R, G, B values. Since the color in each grid after being calculated is the same and near to the color value of the initial picture, the mosaic effect can be obtained.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for adding a dynamic picture to a real-time image comprising steps of:
obtaining a source image;
executing an image processing on the source image to produce an image with a specific format;
integrating a plurality of images with the specific format to produce a dynamic signet image; and
adding the dynamic signet image to a real-time video streaming.

2. The method according to claim 1, wherein the method further comprises the steps of:
storing the dynamic signet image into a database; and
loading a dynamic signet image from the database.

3. The method according to claim 1, wherein the method further comprises the step of adding the loaded dynamic signet image to the real-time video streaming by a filter.

4. The method according to claim 3, wherein the method further comprises the steps of:
determining a position to put the dynamic signet image when the dynamic signet image is loaded from a database; and
adding each image of the dynamic signet image to the frames of the real-time video streaming by the filter according to the time point when the dynamic signet image is loaded, the time point of showing each image of the dynamic signet image, and a time interval each image of the dynamic signet image lasts.

5. The method according to claim 1, wherein the dynamic signet image is an image with a portable network graphics (PNG) format.

6. The method according to claim 1, wherein the method further comprises the step of executing the image processing on the source image to produce an image with a portable network graphics (PNG) format.

7. The method according to claim 1, wherein the method further comprises the step of executing a masking processing on the source image to make the outline of the source image identical with the outline of the mask.

8. A system for adding a dynamic picture to a real-time image, the system comprising:
a storage medium;
an image capture device for obtaining a source image;
a dynamic signet producing module coupled to the storage medium and the image capture device, wherein the dynamic signet producing module is used to execute an image processing on the source image to produce an image with a specific format, integrate a plurality of images with the specific format to produce a dynamic signet image, and store the dynamic signet image into the storage medium; and
a video processing module coupled to the storage medium and the image capture device, wherein the video processing module is used to load a dynamic signet image from a database and add the loaded dynamic signet image to a real-time video streaming.

9. The system according to claim 8, wherein the video processing module further comprises a filter for adding the loaded dynamic signet image to the real-time video streaming.

10. The system according to claim 9, wherein when the filter loads the dynamic signet image from the database, the filter determines a position to put the dynamic signet image, and adds each image of the dynamic signet image to the frames of the real-time video streaming according to a time point when the dynamic signet image is loaded, a time point of showing each image of the dynamic signet image, and a time interval each of the dynamic signet image lasts.

11. The system according to claim 7, wherein the dynamic signet image is an image with a portable network graphics (PNG) format.

12. The system according to claim 7, wherein the dynamic signet producing module further comprises a masking module for executing a masking processing on the source image to make the outline of the source image identical with the outline of the mask.
